(19) United States
(12) Patent Application Publication
(10) Pub. No.: US 2024/0337543 A1
(43) Pub. Date: Oct. 10, 2024

(54) ULTRA-PRECISION CUTTING QUASI-STATIC FORCE MEASUREMENT SYSTEM BASED ON PIEZOELECTRIC CERAMIC SENSOR

(71) Applicants: ZHEJIANG UNIVERSITY, Hangzhou (CN); ZJU-HANGZHOU GLOBAL SCIENTIFIC AND TECHNOLOGICAL INNOVATION CENTER, Hangzhou (CN)

(72) Inventors: Yuanliu CHEN, Hangzhou (CN); Fuwen CHEN, Hangzhou (CN); Huanbin LIN, Hangzhou (CN); Zhongwei LI, Hangzhou (CN); Bingfeng JU, Hangzhou (CN)

(21) Appl. No.: 18/746,110

(22) Filed: Jun. 18, 2024

Related U.S. Application Data
(63) Continuation of application No. PCT/CN2021/139402, filed on Dec. 18, 2021.

(51) Int. Cl. G01L 1/16; B23Q 17/09; G01L 5/00

(52) U.S. Cl. CPC G01L 1/16; B23Q 17/0966; G01L 5/0076

(57) ABSTRACT

The present invention relates to the field of ultra-precision cutting technology, specifically to a ultra-precision cutting quasi-static force measurement system based on piezoelectric ceramic sensor. This system includes a piezoelectric ceramic force sensing unit that responds to the force applied by a single-point diamond tool and generates an electric charge signal sent to an external post-processing module. The post-processing module includes a preamplifier circuit for the charge, a low-pass filter circuit, an ADC (Analog-to-Digital Converter) module, a DSP (Digital Signal Processor) and a computer. The computer calculates the actual force Fᵢ applied to the piezoelectric ceramic force sensor at moment i based on the solution of the dynamically changing force fᵢ at each moment and the accumulation of the dynamically changing forces from previous moment.

### CROSS-REFERENCE TO RELATED APPLICATIONS

The present application is a continuation of International Application No. PCT/CN2021/139402, with an international filing date of Dec. 18, 2021, the entire contents of which are incorporated herein by reference.

### TECHNICAL FIELD

The invention relates to the field of ultra-precision cutting technology, specifically a ultra-precision cutting quasi-static force measurement system based on piezoelectric ceramic sensor.

### BACKGROUND

Ultra-precision cutting technology employs ultra-precision lathes with nanometer positioning accuracy and diamond tools that are sharp, hard, and wear-resistant. It achieves geometric surfaces by precisely controlling the relative motion trajectory between the tool and the workpiece, resulting in nanometer-level surface roughness and submicron-level shape precision micro-nanostructured surfaces. This technology is an important means for manufacturing optical components with micro-nano fine structures or high-precision shapes and is widely used in fields such as aerospace, national defense, information communication, life sciences, and material science. It is a significant branch in the field of ultra-precision machining.

In response to the trend towards extreme sizes of workpieces, complexities of machined surface shapes, and refinements of machined structures, as well as the market prospects for cross-scale micro-nanostructured surfaces (a type of surface with specific functions formed by large-scale distribution of micro-nano fine structures over large dimensions according to certain geometric rules), there is a need for effective online detection during the cross-scale machining process that involves ultra-long durations and high dynamic processes.

Cutting force can reflect the effective information of the machining state, hence, it is common to monitor the ultra-precision cutting process by detecting the variations in cutting force in real-time.

(1) Traditional methods for detecting ultra-precision cutting forces primarily rely on commercial dynamometers. However, existing commercial dynamometers suffer from poor structural dexterity, making it difficult to integrate them into ultra-precision cutting devices for high dynamic and sensitive cutting force detection.

(2) Piezoelectric ceramics, based on the positive piezoelectric effect, can be used as force sensors and have the advantages of being structurally nimble and highly sensitive. They are often integrated into the end of ultra-precision cutting tools/workpieces to detect the cutting forces during the machining process. Nevertheless, piezoelectric ceramics face a serious issue with charge leakage and are commonly used to detect alternating dynamic force processes (where the force variation continually charges the piezoelectric ceramic to compensate for charge leakage), making it challenging to detect static or quasi-static forces. Since the cutting process encompasses both dynamic and quasi-static components, a piezoelectric ceramic force sensor capable only of detecting dynamic forces but not quasi-static ones falls short of meeting the complete requirements for ultra-precision cutting state detection.

As shown in FIG. 1(a), when a quasi-static force is applied to the piezoelectric ceramic force sensor, the piezoelectric ceramic generates weak polarization charges, which are amplified by a charge amplifier to produce a pulse voltage. However, due to the discharge effect of the feedback resistor and feedback capacitor circuit in the charge amplifier, this pulse voltage cannot be maintained and rapidly decays. Conversely, when the quasi-static force is removed, the piezoelectric ceramic generates reverse weak polarization charges, which are amplified by the charge amplifier to produce an inverse pulse voltage. Again, due to the discharge effect of the feedback resistor and feedback capacitor circuit in the charge amplifier, this pulse voltage cannot be maintained and rapidly decays. The ideal output result for quasi-static force application and removal is shown in FIG. 1(b), where the output voltage changes and remains stable upon application of the quasi-static force until it is removed. Therefore, limited by the charge leakage issue, piezoelectric ceramic force sensors struggle to detect quasi-static forces over long durations with stability.

### SUMMARY

The purpose of the invention is to provide a method based on dynamic compensation for charge leakage, to realize a ultra-precision cutting quasi-static force measurement system based on piezoelectric ceramic sensor.

The invention achieves its purpose in the following way:

A ultra-precision cutting quasi-static force measurement system based on piezoelectric ceramic sensor includes:

A piezoelectric ceramic force sensing unit, which is located at the machining end of the ultra-precision cutting system and is used for mounting a single-point diamond tool;

The piezoelectric ceramic force sensing unit generates a charge signal to an external post-processing module under the action of the single-point diamond tool; the post-processing module includes:
A Charge Preamplifier Circuit, used to amplify the signals detected by the piezoelectric ceramic force sensing unit;
A low-pass filter circuit, used to filter the output signals of the Charge Preamplifier Circuit;
An ADC (Analog-to-Digital Converter) module, used to convert the voltage signals transmitted from the low-pass filter circuit into corresponding digital signals;
A DSP (Digital Signal Processor) for real-time processing of digital signals, and transmitting processed data to a computer;
A computer, which calculates the actual force Fᵢ acting on the piezoelectric ceramic force sensor at each moment based on the dynamic variation fᵢ of forces at that moment i, by accumulating the dynamic variations of forces from previous moments i;
where:

$${F}_{i} = {F}_{i - 1} + \frac{{U}_{i} - {U}_{i - 1} {e}^{- T / τ}}{c} ;$$

T represents the time interval between moments i and i−1;
τ represents the time constant of charge leakage decay;
Uᵢ represents the actual voltage output of the Charge Preamplifier Circuit at the current moment;
Uᵢ₋₁e^{-T/τ} represents the voltage output Uᵢ₋₁ attenuation from the previous moment due to the charge leakage effect;
c represents the linear coefficient between the output voltage of the Charge Preamplifier Circuit and the force applied to the piezoelectric ceramic.

Preferably, the post-processing module also includes: a dynamic compensation module for charge leakage, which compensates the voltage output Uᵢ of the Charge Preamplifier Circuit at the current moment based on the output voltage change |uᵢ−Uᵢ₋₁| between two adjacent moments and the circuit noise threshold uₜₕ₁, as well as the voltage change |uᵢ−uᵢ₋₁| and the voltage decay threshold uₜₕ₂=uᵢ₋₁(1−e^{-T/τ}) within the period T.

Preferably, the post-processing module also includes: an offset current compensation module, which dynamically compensates Uᵢ=Uᵢ−k₁·i the voltage value Uᵢ at a moment based on a pre-calibrated slope value i of output voltage deviation over time.

Preferably, the post-processing module also includes: a temperature compensation module, which dynamically compensates Uᵢ=Uᵢ−k₂·ΔT; the voltage value Uᵢ at a moment i based on a pre-calibrated slope k₂ value of the correlation between output voltage variation and temperature change, where ΔTᵢ is the change in ambient temperature relative to the moment i.

A ultra-precision cutting quasi-static force measurement method based on piezoelectric ceramic sensor includes the following steps:

Step one, continuously monitor the voltage signal on the piezoelectric ceramic force sensor and record the output value Uᵢ of the charge amplifier at that moment; at the start of cutting, the first detected output value U of the charge amplifier is the actual output voltage U₁ of the charge amplifier at that moment, and calculate the actual force

$${F}_{1} = \frac{{U}_{1}}{c}$$

acting on the piezoelectric ceramic force sensor for the first time;

Step two, use the observed voltage Uᵢ at the current moment and the voltage Uᵢ₋₁ from the previous moment to calculate the dynamic variation voltage ΔUᵢ generated by dynamic forces, that is,

$$Δ {U}_{i} = {U}_{i} - {U}_{i - 1} {e}^{- T / τ} ;$$

T represents the time interval between moments i and i−1;
τ represents the time constant of charge leakage decay;
Uᵢ₋₁e^{-T/τ} represents the voltage output Uᵢ₋₁ attenuation from the previous moment due to the charge leakage effect.

Step three, calculate the dynamic force fᵢ at the current moment,

$${f}_{i} = \frac{Δ {U}_{i}}{c} ;$$

c represents the linear coefficient between the output voltage of the charge amplifier and the force applied to the piezoelectric ceramic.

Step four, based on the calculation of the dynamic variation fᵢ of force at each moment, by accumulating the dynamic variations of force from previous moments, the actual force Fᵢ acting on the piezoelectric ceramic force sensor at the current moment can be obtained, that is

$${F}_{i} = {\sum }_{m = 1}^{i} {f}_{m} = {F}_{i - 1} + {f}_{i} .$$

Preferably, in step one, the voltage signal on the piezoelectric ceramic force sensor is filtered as follows:
Record the change |uᵢ−uᵢ₋₁| in output voltage between two adjacent moments, the circuit noise threshold uₜₕ₁, and the voltage decay threshold uₜₕ₂=uᵢ₋₁(1−e^{-T/τ}) within a period T;
When the change |uᵢ−uᵢ₋₁| in output voltage between two adjacent moments is greater than the circuit noise threshold uₜₕ₁, the output voltage of that moment is used as the calculated value Uᵢ and is substituted into step three;
When the change |uᵢ−uᵢ₋₁| in output voltage between two adjacent moments is less than or equal to the circuit noise threshold uₜₕ₁, but the voltage change is greater than the decay threshold uₜₕ₂, the output voltage uᵢ of that moment is used as the calculated value Uᵢ and is substituted into step three.

When the change |uᵢ−uᵢ₋₁| in output voltage between two adjacent moments is less than or equal to the circuit noise threshold uₜₕ₁, and the voltage change is also less than or equal to the decay threshold uₜₕ₂, the result uᵢ₋₁e^{-T/τ} of the voltage uᵢ₋₁ decay from the previous moment is used as the calculated value Uᵢ for the current moment and is substituted into step three.

Preferably, in step one, offset current compensation is performed: a pre-calibrated slope value k₁ of the deviation of the output voltage over time is used to dynamically compensate Uᵢ the voltage value Uᵢ at a moment i,

$${U}_{i} = {U}_{i} - {k}_{1} \cdot i .$$

Preferably, in step one, temperature compensation is performed: a pre-calibrated slope value k₂ of the correlation between changes in output voltage and temperature changes is used to dynamically compensate Uᵢ the voltage value Uᵢ at moment i,

$${U}_{i} = {U}_{i} - {k}_{2} \cdot Δ {T}_{i} ,$$

ΔTᵢ is the change in ambient temperature of moment i relative to the initial moment's ambient temperature.

The invention exhibits prominent and beneficial technical effects compared to existing technologies:

This invention amplifies the weak charge signals generated by the piezoelectric ceramic force sensor integrated into the ultra-precision cutting device during the force application process through a Charge Preamplifier Circuit. Following the initial amplification, the signal sequentially passes through a low-pass filter circuit and ADC data acquisition, and then undergoes real-time processing in the DSP signal processor. Starting from the principle of charge leakage effect in piezoelectric ceramics, the invention realizes the quasi-static force detection function based on dynamic compensation for charge leakage in the piezoelectric ceramic force sensor. The results obtained from the quasi-static force compensation algorithm described by the invention show that it is not only sensitive to instantaneous changes in applied force but also maintains this sensitivity consistently, thus enabling the measurement of quasi-static forces, meaning it can reflect the actual force acting on the piezoelectric ceramic force sensor at any given moment.

The structure of the invention is ingenious and has good integration performance. Compared to commercial dynamometers with fixed structures that lack flexibility, the method described by this invention is based on ordinary piezoelectric ceramic force sensors. Piezoelectric force sensors are small in size and have an ingenious structure, which makes them convenient to integrate at the tool end of ultra-precision cutting devices as a tool holder, allowing for the perception of ultra-low cutting forces close to the site of the ultra-precision cutting process.

This invention has broad measurable types of forces. The method described is not only capable of performing traditional dynamic force detection functions based on piezoelectric force sensors but also breaks through the limitations caused by charge leakage issues that make it difficult to detect static and quasi-static forces. It achieves comprehensive measurement coverage of dynamic, quasi-static, and static forces based on highly integrated, rigid, and sensitive piezoelectric ceramic force sensors.

### BRIEF DESCRIPTION OF THE DRAWINGS

FIG. 1 illustrates a comparison between the actual output and ideal output of the quasi-static force loading and unloading for the piezoelectric ceramic force sensor.

FIG. 2 is the principle block diagram of the invention;

FIG. 3 is a schematic diagram illustrating the principle of the quasi-static force measurement algorithm based on dynamic compensation for piezoelectric ceramic charge leakage;

FIG. 4 is the block diagram of the quasi-static force measurement algorithm based on charge leakage dynamic compensation;

FIG. 5 is a schematic diagram showing the effect of bias current on the quasi-static force algorithm;

FIG. 6 is a schematic diagram showing the effect of temperature on the quasi-static force algorithm;

FIG. 7 compares the measurement results of the ultra-precision cutting quasi-static force perception system based on the piezoelectric ceramic sensor with those from a commercial dynamometer;

FIG. 8 is the circuit schematic diagram of the invention; and

FIG. 9 is the PCB diagram of the technical solution of the invention.

### DESCRIPTION OF THE EMBODIMENTS

Below, in conjunction with the accompanying figures, provides a further detailed explanation of the specific embodiments of the present invention.

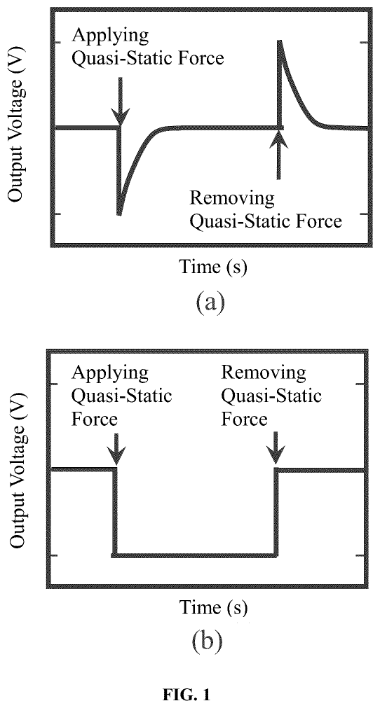

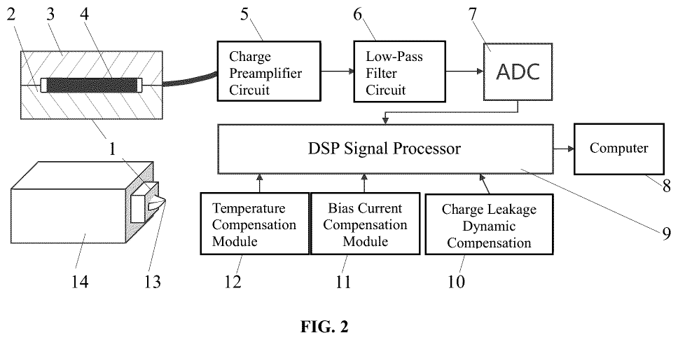

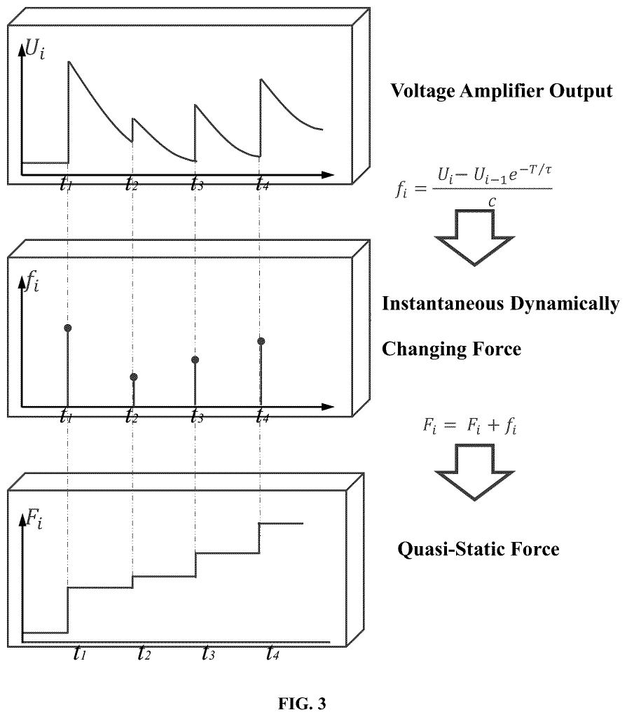

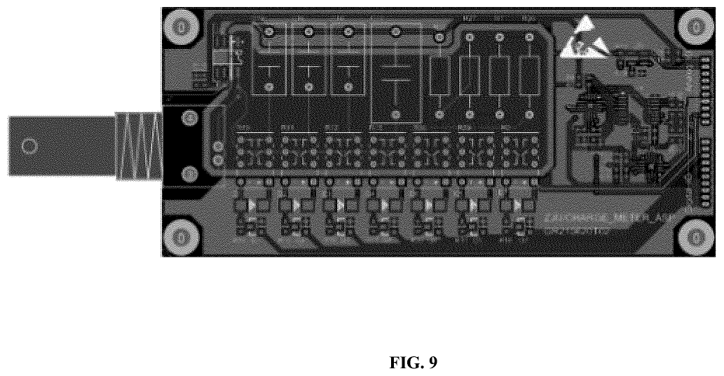

As shown in FIGS. 1-9, the ultra-precision cutting device based on the piezoelectric ceramic sensor described by this invention is an enhancement to traditional single-point diamond ultra-precision cutting systems (such as fast tool servo devices, slow tool servo devices, etc.). By integrating a piezoelectric ceramic force sensing unit, it aims to achieve online monitoring of cutting forces during the ultra-precision cutting process at the tool end, thereby enabling online monitoring of the machining state.

A ultra-precision cutting quasi-static force measurement system based on piezoelectric ceramic sensor includes:

A piezoelectric ceramic force sensing unit 1, located at the machining end of the ultra-precision cutting system 14, and used for mounting the single-point diamond tool 13; The piezoelectric ceramic force sensing unit 1 is a piezoelectric ceramic force sensor integrated into the ultra-precision cutting device, which produces weak charge signals during the application of force;

The piezoelectric ceramic force sensing unit 1, when subjected to the force exerted by the single-point diamond tool 13, generates a charge signal that is transmitted to an external post-processing module. This post-processing module includes:
A preamplifier circuit 5 for amplifying the signals detected by the piezoelectric ceramic force sensing unit 1;
A low-pass filter circuit 6 for filtering the output signal from the preamplifier circuit;
An ADC module 7 for converting the voltage signal passed from the low-pass filter circuit 6 into a corresponding digital signal;
A DSP signal processor 9 for real-time processing of the digital signal and transmitting the processed data to a computer 8; the computer may be an ordinary PC;
The computer 8 calculates the actual force fᵢ acting on the piezoelectric ceramic force sensor based on the dynamic variation of forces at each moment, and obtains the actual force Fᵢ acting on the piezoelectric ceramic force sensor at the moment i by accumulating the dynamic changing force at previous moment i;

$${F}_{i} = {F}_{i - 1} + \frac{{U}_{i} - {U}_{i - 1} {e}^{- T / τ}}{c} ;$$

where
T represents the time interval between moments i and i−1;
τ represents the time constant of charge leakage decay;
Uᵢ represents the actual voltage output of the preamplifier circuit at the current moment;
Uᵢ₋₁e^{-T/τ} represents the result of the voltage output Uᵢ₋₁ from the previous moment decayed by the charge leakage effect;
c represents the linear coefficient between the output voltage of the preamplifier circuit and the force applied to the piezoelectric ceramic, which can be calibrated in advance according to the specific preamplifier circuit used.
e represents the natural constant e.

The time interval T depends on the computational power of the processor, which affects the frequency of real-time processing. The processor used in this invention has an interval of about 1 ms, corresponding to 1 kHz. Theoretically, the stronger the computational power of the processor, the shorter the time interval T and the higher the precision.

Preferably, the post-processing module also includes: a charge leakage dynamic compensation module 10, which compensates the voltage output Uᵢ of the preamplifier circuit at the current moment based on the change |uᵢ−uᵢ₋₁| in output voltage between adjacent moments and the circuit noise threshold uₜₕ₁, as well as the change |uᵢ−uᵢ₋₁| in voltage and the voltage decay threshold uₜₕ₂=Uᵢ₋₁(1−e^{-T/τ}) within the cycle time T.

Preferably, the post-processing module also includes: an offset current compensation module 11, which performs dynamic compensation Uᵢ=Uᵢ−k₁·i on the voltage value Uᵢ at the moment i based on a pre-calibrated slope value k₁ of the deviation of the output voltage over time.

Preferably, the post-processing module also includes: a temperature compensation module 12, which performs dynamic compensation Uᵢ=Uᵢ−k₂·ΔT; on the voltage value Uᵢ at the moment i based on a pre-calibrated slope value k₂ of the correlation between changes in output voltage and temperature changes, where ΔTᵢ is the change in ambient temperature relative to the moment i's ambient temperature.

A ultra-precision cutting quasi-static force measurement method based on piezoelectric ceramic sensor includes the following steps:

Step 1, continuously detect the voltage signal on the piezoelectric ceramic force sensor and record the output value Uᵢ of the charge amplifier at that moment; if the dynamic varying force acting on the piezoelectric ceramic force sensor at any moment is fᵢ, then the contribution of this dynamic force to the output of the charge amplifier at that moment is ΔUᵢ,

$$Δ {U}_{i} = c {f}_{i} ; \qquad ( 1 )$$

At the start of cutting, the initially detected output value Uᵢ of the charge amplifier is the actual output voltage U₁ of the charge amplifier at that moment, and the initial dynamic varying force f₁ is the actual force F₁ initially applied to the piezoelectric ceramic force sensor,

$${F}_{1} = \frac{{U}_{1}}{c} ;$$

Step 2, use the current moment's charge amplifier output value Uᵢ and the previous moment's charge amplifier output value Uᵢ₋₁ to calculate the dynamic varying voltage ΔUᵢ generated due to the dynamic force,

$$Δ {U}_{i} = {U}_{i} - {U}_{i - 1} {e}^{- T / τ} ; \qquad ( 2 )$$

Step 3, calculate the dynamic varying force fᵢ at the current moment,

$${f}_{i} = \frac{Δ {U}_{i}}{c} ; \qquad ( 3 )$$

c represents the linear coefficient between the output voltage of the charge amplifier and the force applied to the piezoelectric ceramic;

Step 4, based on the solution fᵢ of the dynamic varying force at each moment, the actual force Fᵢ acting on the piezoelectric ceramic force sensor at the current moment can be obtained by accumulating the dynamic varying forces from previous moment i, that is

$${F}_{i} = {\sum }_{m = 1}^{i} {f}_{m} = {F}_{i - 1} + {f}_{i} ; \qquad ( 4 )$$

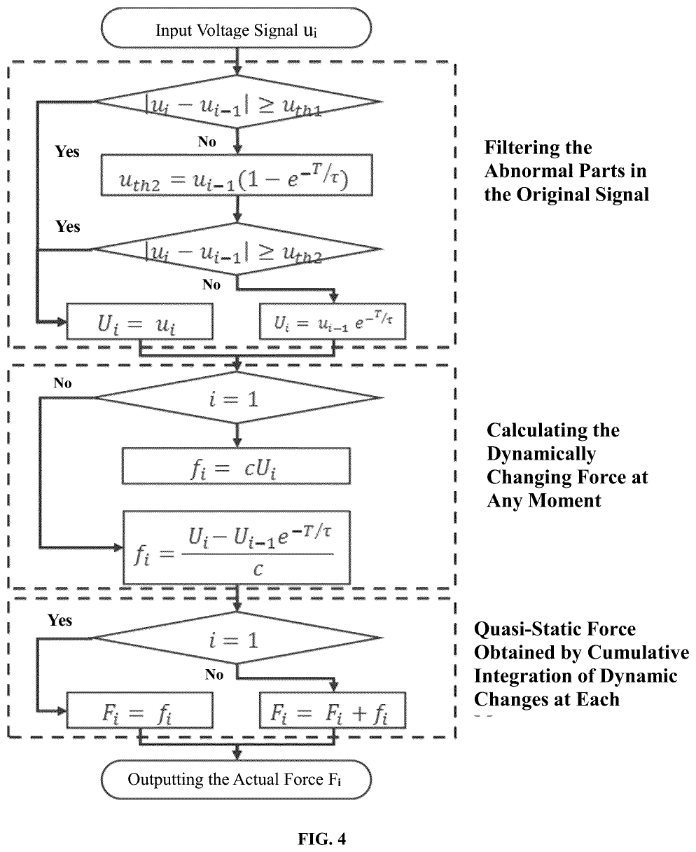

Preferably, in Step 1, as shown in FIG. 4, filter the voltage signal on the piezoelectric ceramic force sensor, as follows:
Record the change |uᵢ−uᵢ₋₁| in output voltage between two adjacent moments, the circuit noise threshold uₜₕ₁, and the voltage decay threshold uₜₕ₂=Uᵢ₋₁(1−e^{-T/τ}) within the cycle time T;
When the change |uᵢ−uᵢ₋₁| in output voltage between two adjacent moments is greater than the circuit noise threshold uₜₕ₁, it indicates that the voltage change is caused by an external dynamic force variation. The output voltage uᵢ of that moment is used as the calculated value Uᵢ and is substituted into formula (3) of Step 3;
When the change |uᵢ−uᵢ₋₁| in output voltage between two adjacent moments is less than or equal to the circuit noise threshold uₜₕ₁, but the voltage change is greater than the decay threshold uₜₕ₂, it indicates that the voltage change is induced by a dynamic force variation. The output voltage uᵢ of that moment is used as the calculated value Uᵢ and is substituted into formula (3) of Step 3;
When the change in output voltage |uᵢ−uᵢ₋₁| between two adjacent moments is less than or equal to the circuit noise threshold uₜₕ₁, and the voltage change is less than or equal to the decay threshold uₜₕ₂, the result uᵢ₋₁e^{-T/τ} of the voltage uᵢ₋₁ decay from the previous moment is used as the current moment's calculated value Uᵢ and is substituted into formula (3) of Step 3.

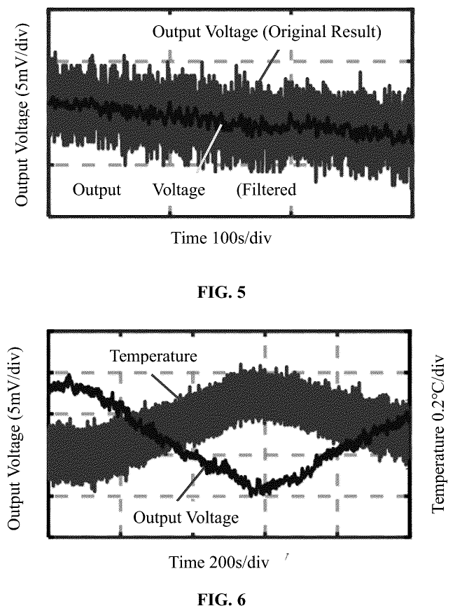

Preferably, in Step 1, as shown in FIG. 5, the offset current is an inherent phenomenon of the charge amplifier. The presence of the offset current leads to a fixed slope deviation in the output voltage of charge amplifier without a powerful input, and the effect of bias current on the output of charge amplifier. Since the effect of the bias current on the output voltage of the charge amplifier is a linear offset, dynamic compensation Uᵢ for the momentary voltage value is achieved by pre-calibrating the slope value k₁ related to the deviation of the output voltage Uᵢ over the moment i. This allows for the implementation of bias current compensation.

$${U}_{i} = {U}_{i} - {k}_{1} \cdot i .$$

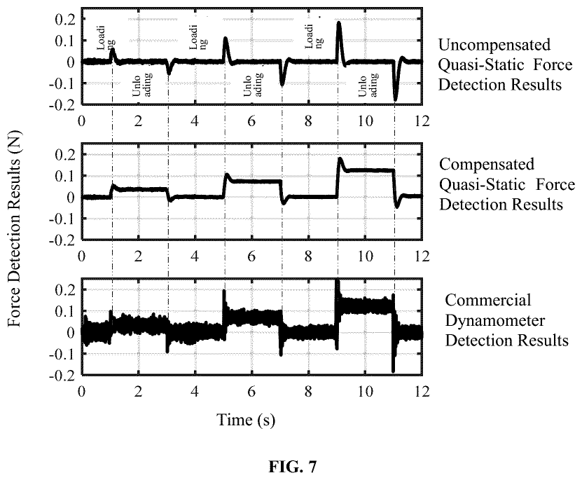

Preferably, in Step 1, as shown in FIG. 6, changes in the ambient temperature can cause deviations in the output voltage of the charge amplifier, thereby affecting the force measurement values calculated based on the output voltage of the charge amplifier. The influence of temperature changes on the output voltage of the charge amplifier shows a linear negative correlation with temperature change. Hence, by pre-calibrating the slope value k₂ related to the change in output voltage with temperature variation, dynamic compensation Uᵢ for the voltage value Uᵢ at the moment i is performed. This allows for the implementation of temperature compensation;

$${U}_{i} = {U}_{i} - {k}_{2} \cdot Δ {T}_{i} ,$$

ΔTᵢ represents the change in ambient temperature relative to the moment i's ambient temperature.

In summary, the function of measuring quasi-static forces with the piezoelectric ceramic force sensor is realized based on charge leakage dynamic compensation, and the precision of quasi-static force detection is achieved through the offset current compensation module and temperature compensation module.

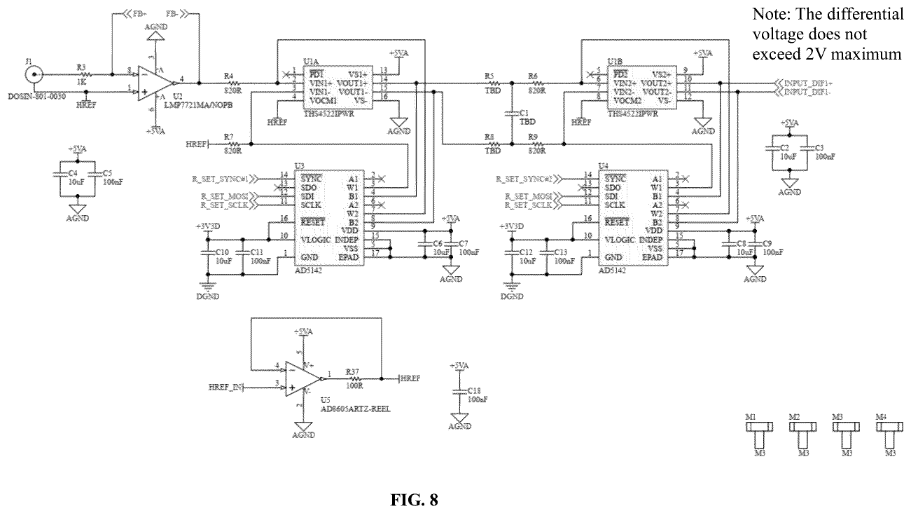

To further verify the effectiveness of the method described in this invention, a comparison was made with a commercial dynamometer, and the results are shown in FIG. 7. The force loading method shown in FIG. 7 involves continuous loading and unloading of quasi-static forces.

In the upper part of FIG. 7, the uncompensated quasi-static force detection results of the piezoelectric ceramic force sensor are displayed. It can be observed that although the sensor outputs a sensitive voltage change at the moment of force variation, this change cannot be sustained, which causes it can't effectively determine the actual force applied to the piezoelectric ceramic force sensor at any given moment.

The middle part of FIG. 7 shows the compensated quasi-static force detection results of the piezoelectric ceramic force sensor according to this invention. It can be seen that not only is there a sensitive change at the moment of force application, but this change is also maintained consistently, thereby enabling the measurement of quasi-static forces; that is, it reflects the actual magnitude of the force acting on the piezoelectric ceramic force sensor at any moment.

The lower part of FIG. 7 displays the detection results from the commercial dynamometer. It is evident that the commercial dynamometer can also respond and maintain changes to quasi-static forces. However, it has greater signal noise, which makes it less sensitive in force detection compared to the method described in this invention, and it is unable to effectively and accurately sense ultra-low cutting forces.

The actual detection process of this system: Each detection starts from zero. At the beginning of cutting, the first detected output value Uᵢ of the charge amplifier is the actual output voltage U₁ of the charge amplifier at that moment, and the first actual force F₁=U₁/c is obtained through the formula. During the second detection, the current output voltage U₂ is used as a basis, and is subtracted the residual charge U₁e^{-T/τ} from U₁ due to charge leakage to obtain the actual increased voltage ΔU₂ for the second detection. Then based on the actual increased voltage ΔU₂, the actual dynamic changing force f₂ is calculated. By accumulating the dynamic changing force f₂ based on the F₁, the actual force F₂ acting on the single-point diamond tool 13 at the current moment can be obtained, and so forth.

The above embodiments and descriptions in the specification are only to illustrate the principles of the invention. Under the premise of not departing from the spirit and scope of the invention, there may be various modifications and improvements, which fall within the scope of the invention as claimed. The scope of protection sought by the invention is defined by the attached claims and their equivalents.

What is claimed is:

1. A ultra-precision cutting quasi-static force measurement system based on piezoelectric ceramic sensor comprises:
a piezoelectric ceramic force sensing unit, located at the machining end of the ultra-precision cutting system, and used for mounting the single-point diamond tool;
the piezoelectric ceramic force sensing unit, when subjected to the force exerted by the single-point diamond tool, generates a charge signal that is transmitted to an external post-processing module; wherein the post-processing module comprises:
a preamplifier circuit for amplifying the signals detected by the piezoelectric ceramic force sensing unit;
a low-pass filter circuit for filtering the output signal from the preamplifier circuit;
an ADC module for converting the voltage signal passed from the low-pass filter circuit into a corresponding digital signal;
a DSP signal processor for real-time processing of the digital signal and transmitting the processed data to a computer;
the computer calculates the actual force fᵢ acting on the piezoelectric ceramic force sensor based on the dynamic variation of forces at each moment, and obtains the actual force Fᵢ acting on the piezoelectric ceramic force sensor at the moment i by accumulating the dynamic changing force at moment i;
$${F}_{i} = {F}_{i - 1} + \frac{{U}_{i} - {U}_{i - 1} {e}^{- T / τ}}{c} ;$$
T represents the time interval between moments i and i−1;
τ represents the time constant of charge leakage decay;
Uᵢ represents the actual voltage output of the preamplifier circuit at the current moment;
Uᵢ₋₁e^{-T/τ} represents the result of the voltage output Uᵢ₋₁ from the previous moment decayed by the charge leakage effect;
c represents the linear coefficient between the output voltage of the preamplifier circuit and the force applied to the piezoelectric ceramic.

2. The system according to claim 1, wherein the post-processing module further comprises: a charge leakage dynamic compensation module, which compensates the voltage output Uᵢ of the preamplifier circuit at the current moment based on the change |uᵢ−uᵢ₋₁| in output voltage between adjacent moments and the circuit noise threshold uₜₕ₁, as well as the change |uᵢ−uᵢ₋₁| in voltage and the voltage decay threshold uₜₕ₂=Uᵢ₋₁(1−e^{-T/τ}) within the cycle time T.

3. The system according to claim 1, wherein the post-processing module further comprises: an offset current compensation module, which performs dynamic compensation Uᵢ=Uᵢ−K₁·i on the voltage value Uᵢ at the moment i based on a pre-calibrated slope value k₁ of the deviation of the output voltage over time.

4. The system according to claim 1, wherein the post-processing module further comprises: a temperature compensation module, which performs dynamic compensation Uᵢ=Uᵢ−k₂·ΔTᵢ on the voltage value Uᵢ at the moment i based on a pre-calibrated slope value k₂ of the correlation between changes in output voltage and temperature changes, where ΔTᵢ is the change in ambient temperature relative to the moment i's ambient temperature.

5. A ultra-precision cutting quasi-static force measurement method based on piezoelectric ceramic sensor comprises the following steps:
step one, continuously detect the voltage signal on the piezoelectric ceramic force sensor and record the output value Uᵢ of the charge amplifier at that moment; at the start of cutting, the initially detected output value Uᵢ of the charge amplifier is the actual output voltage U₁ of the charge amplifier at that moment, and calculating the actual force applied to the piezoelectric ceramic force sensor for the first time; where
c represents the linear coefficient between the output voltage of the charge amplifier and the force applied to the piezoelectric ceramic;
step two, use the current moment's charge amplifier output value Uᵢ and the previous moment's charge amplifier output value Uᵢ₋₁ to calculate the dynamic varying voltage ΔUᵢ generated due to the dynamic force,
$$Δ {U}_{i} = {U}_{i} - {U}_{i - 1} {e}^{- T / τ} ;$$
T represents the time interval between moments i and i−1;
τ represents the time constant of charge leakage decay;
Uᵢ₋₁e^{-T/τ} represents the result of the voltage output Uᵢ₋₁ from the previous moment decayed by the charge leakage effect;
step three, calculate the dynamic varying force fᵢ at the current moment,
$${f}_{i} = \frac{Δ {U}_{i}}{c} ;$$
step four, based on the solution fᵢ of the dynamic varying force at each moment, the actual force Fᵢ acting on the piezoelectric ceramic force sensor at the current moment can be obtained by accumulating the dynamic varying forces from previous moment i, that is
$${F}_{i} = {\sum }_{m = 1}^{i} {f}_{m} = {F}_{i - 1} + {f}_{i} .$$

6. The method according to claim 5, wherein in step one, filter the voltage signal on the piezoelectric ceramic force sensor, as follows:
record the change |uᵢ−uᵢ₋₁| in output voltage between two adjacent moments, the circuit noise threshold uₜₕ₁, and the voltage decay threshold uₜₕ₂=Uᵢ₋₁(1−e^{-T/τ}) within the cycle time T;
when the change |uᵢ−uᵢ₋₁| in output voltage between two adjacent moments is greater than the circuit noise threshold uₜₕ₁, it indicates that the voltage change is caused by an external dynamic force variation; the output voltage uᵢ of that moment is used as the calculated value Uᵢ and is substituted into step three;
when the change |uᵢ−uᵢ₋₁| in output voltage between two adjacent moments is less than or equal to the circuit noise threshold uₜₕ₁, but the voltage change is greater than the decay threshold uₜₕ₂, it indicates that the voltage change is induced by a dynamic force variation; the output voltage uᵢ of that moment is used as the calculated value Uᵢ and is substituted into step three;
when the change in output voltage |uᵢ−uᵢ₋₁| between two adjacent moments is less than or equal to the circuit noise threshold uₜₕ₁, and the voltage change is less than or equal to the decay threshold uₜₕ₂, the result uᵢ₋₁e^{-T/τ} of the voltage uᵢ₋₁ decay from the previous moment is used as the current moment's calculated value Uᵢ and is substituted into step three.

7. The method according to claim 5, wherein in step one, an offset current compensation is performed: a slope value k₁ related to the deviation of the output voltage over time is pre-calibrated to give dynamic compensation Uᵢ of the voltage value Uᵢ over the moment i;
$${U}_{1} = {U}_{i} - {k}_{1} \cdot i .$$

8. The method according to claim 5, wherein in step one, a temperature compensation is performed: a slope value k₂ related to the deviation of the output voltage over time is pre-calibrated to give dynamic compensation Uᵢ of the voltage value Uᵢ over the moment i.
$${U}_{i} = {U}_{i} - {k}_{2} \cdot Δ {T}_{i} ,$$
ΔTᵢ represents the change in ambient temperature relative to the moment i's ambient temperature.
